(19) United States
(12) Patent Application Publication
(10) Pub. No.: US 2020/0108704 A1
(43) Pub. Date: Apr. 9, 2020

(54) CUSHIONED VEHICLE COVER ASSEMBLY

(71) Applicant: Judy Smith, Athens, AL (US)

(72) Inventor: Judy Smith, Athens, AL (US)

(21) Appl. No.: 16/451,531

(22) Filed: Jun. 25, 2019

Related U.S. Application Data
(63) Continuation-in-part of application No. 16/155,331, filed on Oct. 9, 2018, now abandoned.

(51) Int. Cl. B60J 11/04

(52) U.S. Cl. CPC B60J 11/04

(57) ABSTRACT

A cushioned vehicle cover assembly for protecting a vehicle from impact damage includes a vehicle that has a plurality of body panels thereon. A cover is removably positionable over the vehicle when the vehicle is parked outdoors. The cover is comprised of a fluid impermeable material. Moreover, the cover is comprised of a deformable material thereby facilitating the cover to conform to the outwardly facing surface of the body panels. A cushion is coupled to the cover and the cushion is comprised of a resiliently compressible material. The cushion absorbs impact energy from hail and other falling objects thereby protecting the vehicle from impact damage.

### CROSS-REFERENCE TO RELATED APPLICATIONS

This application is a continuation in part of U.S. application Ser. No. 16/155,331, filed Oct. 9, 2018, now abandoned.

### STATEMENT REGARDING FEDERALLY SPONSORED RESEARCH OR DEVELOPMENT

Not Applicable

### THE NAMES OF THE PARTIES TO A JOINT RESEARCH AGREEMENT Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to vehicle cover devices and more particularly pertains to a new vehicle cover device for protecting a vehicle from impact damage.

### BRIEF SUMMARY OF THE INVENTION

An embodiment of the disclosure meets the needs presented above by generally comprising a vehicle that has a plurality of body panels thereon. A cover is removably positionable over the vehicle when the vehicle is parked outdoors. The cover is comprised of a fluid impermeable material. Moreover, the cover is comprised of a deformable material thereby facilitating the cover to conform to the outwardly facing surface of the body panels. A cushion is coupled to the cover and the cushion is comprised of a resiliently compressible material. The cushion absorbs impact energy from hail and other falling objects thereby protecting the vehicle from impact damage.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective phantom view of a cushioned vehicle cover assembly according to an embodiment of the disclosure.

FIG. 2 is a bottom view of a cover of an embodiment of the disclosure.

FIG. 3 is a cross sectional view taken along line 3-3 of FIG. 2 of an embodiment of the disclosure.

FIG. 4 is an exploded perspective view of an embodiment of the disclosure.

FIG. 5 is a perspective in-use view of an embodiment of the disclosure.

FIG. 6 is a side in-use view of an embodiment of the disclosure on a pickup truck.

FIG. 7 is a side in-use view of an embodiment of the disclosure on a semi-trailer truck.

FIG. 8 is a side in-use view of an embodiment of the disclosure on a boat.

### DETAILED DESCRIPTION OF THE INVENTION

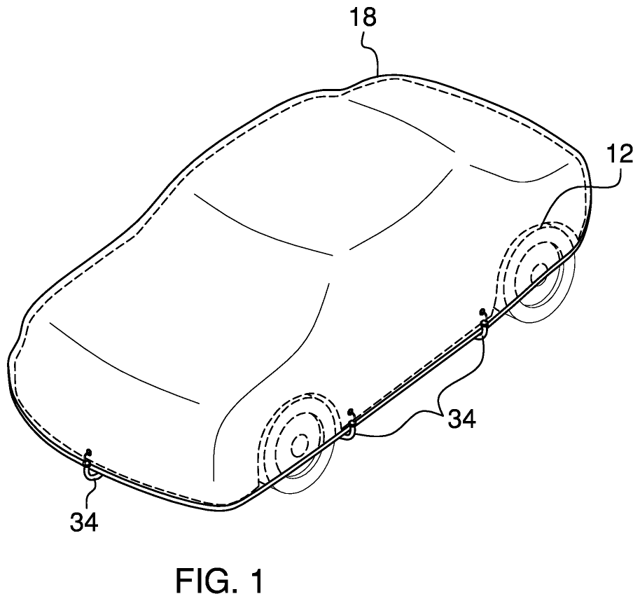

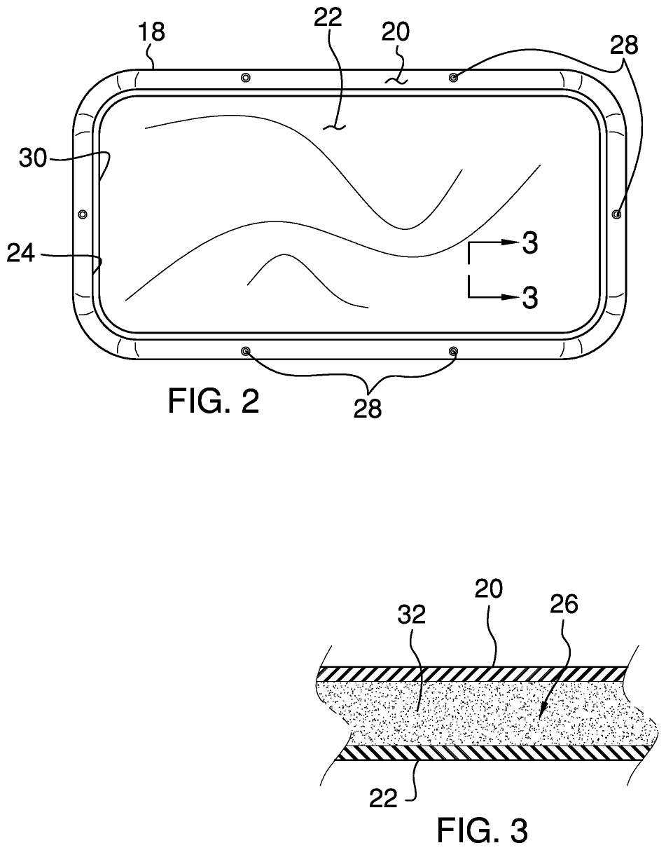

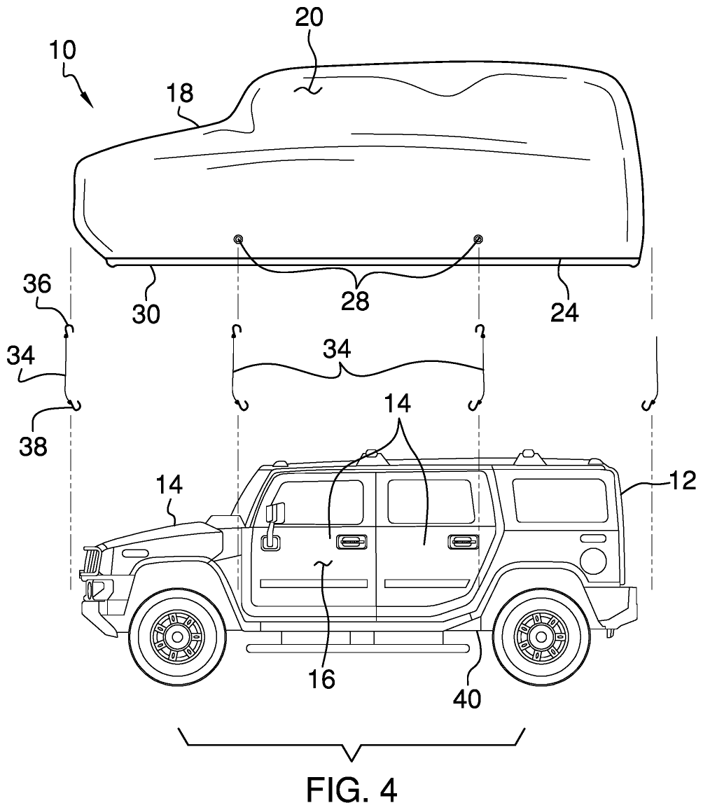

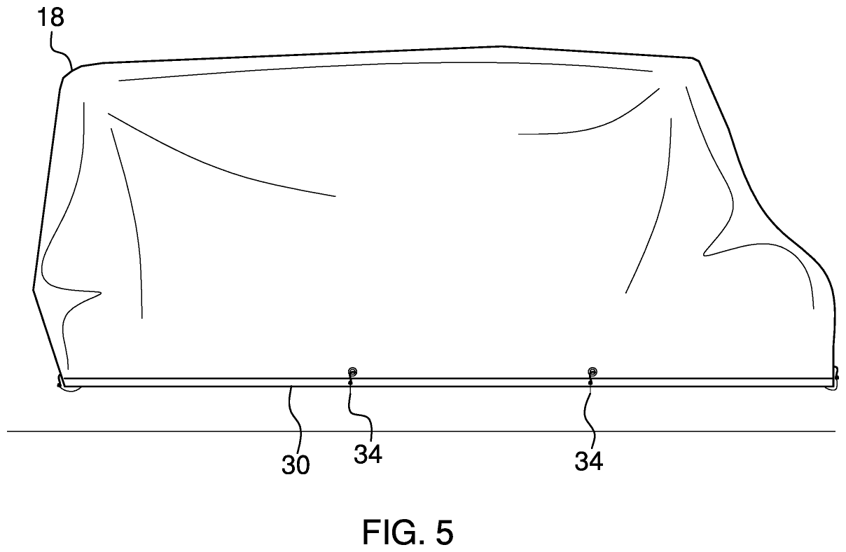

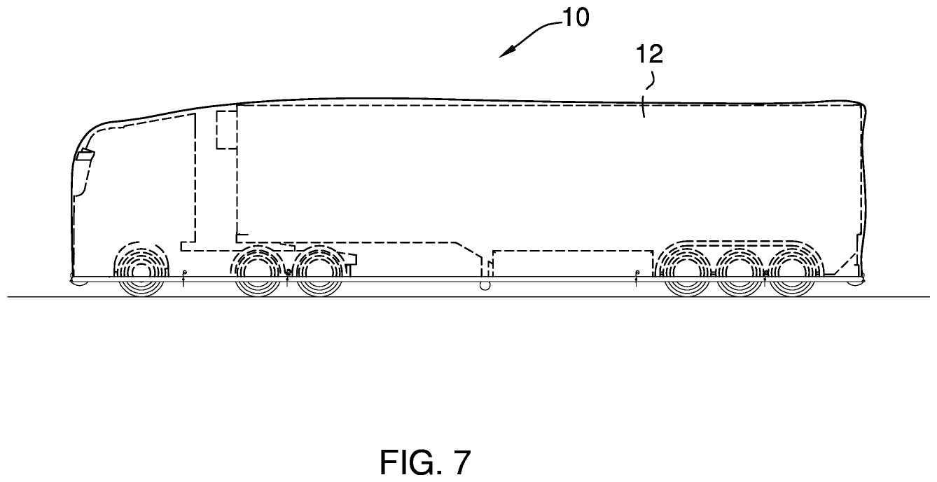

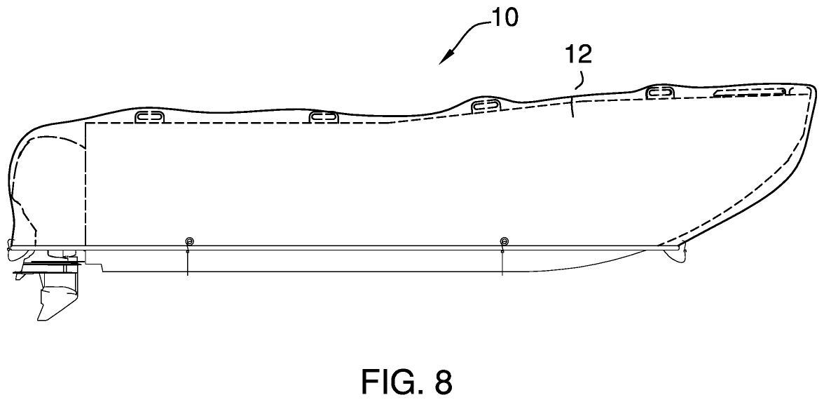

With reference now to the drawings, and in particular to FIGS. 1 through 8 thereof, a new vehicle cover device embodying the principles and concepts of an embodiment of the disclosure and generally designated by the reference numeral 10 will be described.

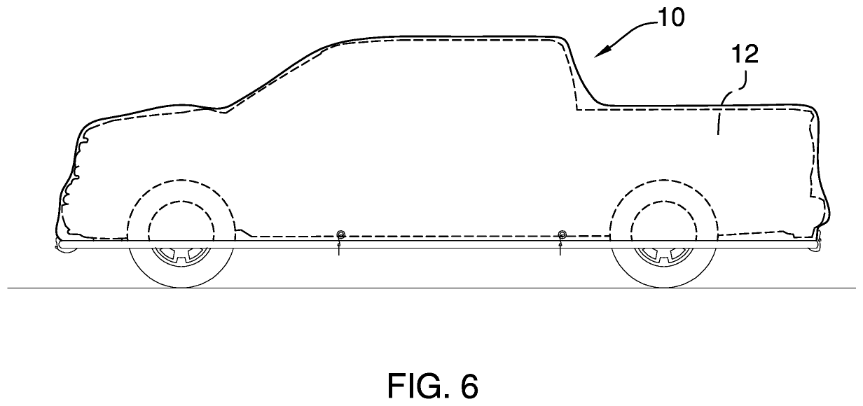

As best illustrated in FIGS. 1 through 8, the cushioned vehicle cover assembly 10 generally comprises a vehicle 12 that has a plurality of body panels 14 thereon, and each of the body panels 14 has an outwardly facing surface 16. The vehicle 12 may be a passenger vehicle, a recreational vehicle, a cargo vehicle or any other vehicle 12. FIGS. 6 through 8 show examples of vehicles 12 with the assembly 10 in use. Additionally, the body panels 14 may be comprised of a rigid material that is vulnerable to impact damage. A cover 18 is provided and the cover 18 is removably positionable over the vehicle 12 when the vehicle 12 is parked outdoors. The cover 18 is comprised of a fluid impermeable material to protect the vehicle 12 from precipitation and other fluids. Additionally, the cover 18 is comprised of a deformable material thereby facilitating the cover 18 to conform to the outwardly facing surface 16 of the body panels 14. The cover 18 may be manufactured in a variety of dimensions thereby facilitating the cover 18 to accommodate any size of vehicle 12 and varieties_including, but not limited to, semi-trucks and trailers, trucks, passenger cars, and boats.

The cover 18 has a first surface 20, a second surface 22 and a perimeter edge 24 extending therebetween to define a cushion space 26 between the first 20 and second 22 surfaces. The second surface 22 rests on the outwardly facing surface 16 of the body panels 14 when the cover 18 is positioned over the vehicle 12. The cover 18 has a plurality of apertures 28 each extending through the first 20 and second 22 surfaces and the apertures 28 is spaced apart from each other. Moreover, each of the apertures 28 are spaced from the perimeter edge 24 and are distributed along the perimeter edge 24. An elastic member 30 is coupled to the cover 18 and the elastic member 30 is aligned with the perimeter edge 24 of the cover 18. Thus, the elastic member 30 tightens the perimeter edge 24 against the vehicle 12 when the cover 18 is positioned over the vehicle 12.

A cushion 32 is provided and the cushion 32 is coupled to the cover 18. The cushion 32 is comprised of a resiliently compressible material to absorb impact energy from hail and other falling objects. In this way the cushion 32 protects the vehicle 12 from impact damage. The cushion 32 is positioned in and completely fills the cushion space 26 between the first 20 and second 22 surfaces of the cover 18.

A plurality of fasteners 34 is provided and each of the fasteners 34 releasably engages the cover 18. Each of the fasteners 34 releasably engages the vehicle 12 to retain the cover 18 on the vehicle 12. Each of the fasteners 34 has a first end 36 and a second end 38. The first end 36 of each of the fasteners 34 engages a respective one of the apertures 28 in the cover 18 and the second end 38 of each of the fasteners 34 engages the vehicle 12. Each of the fasteners 34 may comprise a bungee cord or the like that includes a pair of hooks associated therewith. Each of the hooks may be positioned on a respective one of the first 36 and second 38 ends of the associated fastener 34.

In use, the cover 18 is positioned over the vehicle 12 when the vehicle 12 is positioned outdoors. Each of the fasteners 34 is manipulated to engage the respective aperture 28 and a bottom side 40 of the vehicle 12. In this way the cover 18 is retained on the vehicle 12 such that the cover 18 cannot be removed from the vehicle 12 by wind or the like. The cushion 32 absorbs impact energy from falling objects, such as hail or the like. In this way the body panels 14 on the vehicle 12 are protected from being damaged by the falling objects. The fasteners 34 and the cover 18 are removed from the vehicle 12 prior to driving the vehicle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cushioned vehicle cover assembly being configured to protect a vehicle from impact damage, said assembly comprising:
a vehicle having a plurality of body panels thereon;
a cover being removably positionable over said vehicle when said vehicle is parked outdoors, said cover being comprised of a fluid impermeable material, said cover being comprised of a deformable material thereby facilitating said cover to conform to said outwardly facing surface of said body panels; and
a cushion being coupled to said cover, said cushion being comprised of a resiliently compressible material wherein said cushion is configured to absorb impact energy from hail and other falling objects thereby protecting said vehicle from impact damage.

2. The assembly according to claim 1, wherein:
each of said body panels has an outwardly facing surface;
said cover has a first surface, a second surface and a perimeter edge extending therebetween to define a cushion space between said first and second surfaces, said second surface resting on said outwardly facing surface of said body panels when said cover is positioned over said vehicle.

3. The assembly according to claim 2, wherein said cover has a plurality of apertures each extending through said first and second surfaces, said apertures being spaced apart from each other, each of said apertures being spaced from said perimeter edge and being distributed along said perimeter edge.

4. The assembly according to claim 2, wherein said cushion is positioned in and completely fills said cushion space between said first and second surfaces of said cover.

5. The assembly according to claim 3, further comprising a plurality of fasteners, each of said fasteners releasably engaging said cover, each of said fasteners releasably engaging said vehicle to retain said cover on said vehicle, each of said fasteners having a first end and a second end, said first end of each of said fasteners engaging a respective one of said apertures in said cover, said second end of each of said fasteners engaging said vehicle.

6. A cushioned vehicle cover assembly being configured to protect a vehicle from impact damage, said assembly comprising:
a vehicle having a plurality of body panels thereon, each of said body panels having an outwardly facing surface;
a cover being removably positionable over said vehicle when said vehicle is parked outdoors, said cover being comprised of a fluid impermeable material, said cover being comprised of a deformable material thereby facilitating said cover to conform to said outwardly facing surface of said body panels, said cover having a first surface, a second surface and a perimeter edge extending therebetween to define a cushion space between said first and second surfaces, said second surface resting on said outwardly facing surface of said body panels when said cover is positioned over said vehicle, said cover having a plurality of apertures each extending through said first and second surfaces, said apertures being spaced apart from each other, each of said apertures being spaced from said perimeter edge and being distributed along said perimeter edge;
a cushion being coupled to said cover, said cushion being comprised of a resiliently compressible material wherein said cushion is configured to absorb impact energy from hail and other falling objects thereby protecting said vehicle from impact damage, said cushion being positioned in and completely filling said cushion space between said first and second surfaces of said cover; and
a plurality of fasteners, each of said fasteners releasably engaging said cover, each of said fasteners releasably engaging said vehicle to retain said cover on said vehicle, each of said fasteners having a first end and a second end, said first end of each of said fasteners engaging a respective one of said apertures in said cover, said second end of each of said fasteners engaging said vehicle.
